(19) United States
(12) Patent Application Publication
(10) Pub. No.: US 2022/0159816 A1
(43) Pub. Date: May 19, 2022

(54) APPARATUS AND METHOD FOR A REMOTE CONTROL OF EMERGENCY LIGHTING EQUIPMENT

(71) Applicant: BEGHELLI SPA, Valsamoggia (Bologna) (IT)

(72) Inventor: Gian Pietro BEGHELLI, Valsamoggia (Bologna) (IT)

(21) Appl. No.: 17/593,818

(22) PCT Filed: Mar. 12, 2020
(86) PCT No.: PCT/IT2020/050060

§ 371 Date: Sep. 24, 2021

(30) Foreign Application Priority Data
Mar. 26, 2019 (IT) 102019000004351

(51) Int. Cl. H05B 47/195; H05B 47/18

(52) U.S. Cl. CPC H05B 47/195; H05B 47/18

(57) ABSTRACT

Described is an apparatus for the remote control of emergency lighting equipment (12, L1, L2, . . . , LN), comprising a smartphone or tablet (11), equipped with a flash designed to send optical commands in the form of coded luminous messages, and a control, programming and storage system, managed by an APR (14), designed to modulate the switching ON and OFF of the flash of the smartphone or tablet (11) for sending coded luminous messages, and at least one lighting appliance or emergency lamp (12, L1, L2, . . . , LN). The emergency lamp (12, L1, L2 . . . , LN) is able to receive the optical commands in order to carry out operational and/or configuration mode tests both during installation and for a predetermined period of time starting from the moment in which the electrical power supply is restored to the lamp after being removed for a defined period of time.

This invention relates generically to an apparatus and to the relative method for the remote control of emergency lighting equipment.

More in detail, the invention relates to an apparatus which uses the flash integrated in smartphones for sending commands and configuration parameters to the emergency lighting equipment; according to further embodiments of the apparatus, it is also possible to manage maintenance register of the systems on cloud, perform an immediate and thorough diagnosis of any fault and immediately and automatically send the request for spare parts.

The technical solution according to the invention comprises emergency lighting equipment equipped with a special luminous sensor, an internal decoding circuit and an optical direction system, so that it can be controlled by the luminous signal, suitably regulated and set up, coming from a smartphone, its operation in turn controlled by a special software application program (APP).

Emergency lighting equipment are devices designed for the safety of persons, which are indispensable to control the exit from premises in the case of emergency and hazardous situations in which the ordinary lighting fails.

Their service status is therefore a critical element and the regular maintenance must be ensured following regular checks which allow the overall status to be kept under control.

For this reason, “intelligent” systems have been developed over time which are able to perform the tests at predetermined intervals or following commands provided by single control points.

However, the situations are very widespread in which the systems are made, for various reasons, with traditional emergency lighting equipment, that is to say, without diagnostics tools, and wherein the checking of the functionality is carried out by the person responsible for the system or an appointed technician.

The operational tests for the emergency lighting equipment are still carried out as follows:

product tests carried out with a button outside the equipment (provided in the technical references standards as the valid test method, this test comprises inserting an NC test button on the equipment power supply line, so as to cause a desired mains supply interruption and the consequent switching ON of the product);
product tests carried out with a button on the product (the button is positioned on the body of the equipment, sometimes beneath a protective cover, and the operator must actuate it directly or, if feasible, with the use of an actuator);
product tests carried out with an electromagnetic command REED (the test is performed by actuating an electromagnetic button positioned inside the product, close to the outer surfaces of the casing, and, as in the previous case, it is actuated directly);
product tests carried out with a radio command (in this case, by using a remote control unit, a radio signal is sent to the product, which, equipped with a special decoding and actuation circuit, resolves the command and carries out the test);
product test carried out with infrared control device (the operation is similar to the control case with radio command).

However, all the methods described above are still not very practical and are costly, since the tests are carried out manually and with significant execution times; moreover, they require specific system parts for carrying out simple operational tests, as well as the skills of specialised users to carry out the tests and to understand the meaning of the signals sent by the product.

The aim of the invention is therefore to make an apparatus for the remote control of emergency lighting equipment, which allows the emergency lighting equipment to be interrogated and programmed in a practical and economic manner, reducing the times for performance of the tests and not comprising manual operations (except for the actuation of the “touch-screen” of a smartphone).

Another aim of the invention is to make an apparatus for the remote control of emergency lighting equipment which allows a maintenance register for the systems to be managed in accordance with the current regulations.

Another aim of the invention is to make an apparatus for the remote control of emergency lighting equipment which allows an immediate and thorough diagnosis of the equipment to be performed, as well as of any faults detected, automatically sending the requests for any necessary spare parts. Another aim of the invention is to indicate a method for the remote control of the emergency lighting equipment which allows regular inspections and maintenance of the equipment to be performed more quickly, more safely and with greater precision, compared with the prior art.

A further aim of the invention is to make an apparatus and a relative method for the remote control of emergency lighting equipment which is reliable and safe and which can also be used by an un-skilled user.

These and other aims, which are described in more detail below, are achieved by an apparatus for the remote control of emergency lighting equipment, according to appended claim 1; other detailed technical characteristics of the equipment and of the relative method according to the invention are disclosed in the following dependent claims.

Advantageously, the apparatus allows the use of the flash integrated in smartphones for communicating with the emergency lighting equipment for maintaining their good operation; in fact, the ageing of the emergency lighting equipment, just like any other device, is normal and inevitable and the maintenance of their good operation implies checks and regular maintenance, in order to keep the system in an efficient and functional condition.

According to the invention, the installer and the maintenance technician can, thanks to an application program installed on the smartphone, communicate with new generation emergency lighting equipment, so as to transmit information to each single lamp and/or to each centralised system.

The apparatus according to the invention comprises substantially two devices: a transmitter apparatus consisting of the flash of a smartphone and an emergency lighting apparatus (lamp), which incorporates a receiving device comprising an element sensitive to the light associated with a decoding and control circuit, which allows the emergency lamp to actuate auto-tests and/or perform other functions. In particular, the emergency lamp according to the invention can be used in various scenarios and the scalability is its main feature.

Further features and advantages of the invention will become more apparent from the following description, relative to various embodiments of the apparatus for the remote control of emergency lighting equipment, which is the object of the invention, provided by way of example, but without limiting the scope of the invention, and with reference to the accompanying drawings, in which:

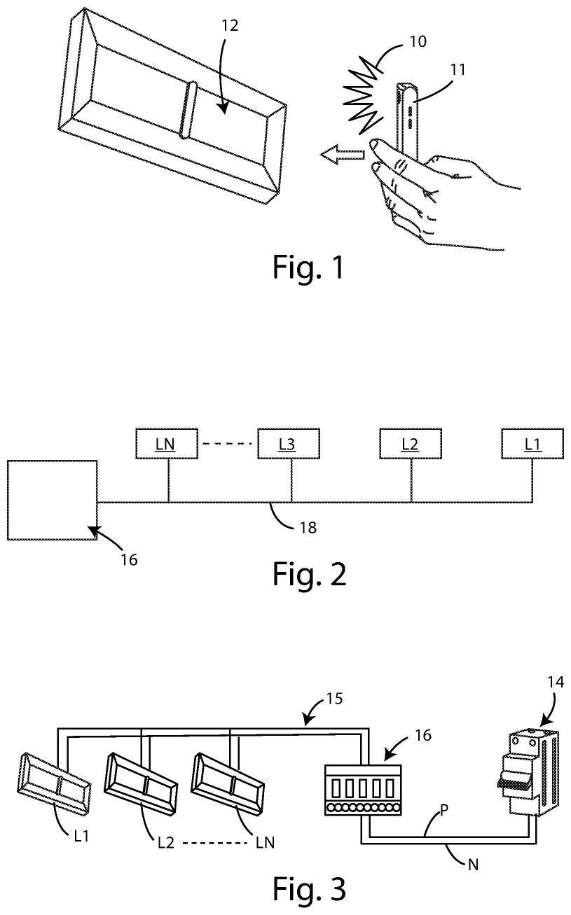

FIG. 1 shows a schematic view of a first operating mode of the apparatus for the remote control of emergency lighting equipment, according to the invention;

FIGS. 2 and 3 show two block diagrams of a possible configuration of emergency lighting equipment controlled remotely by the control apparatus according to the invention;

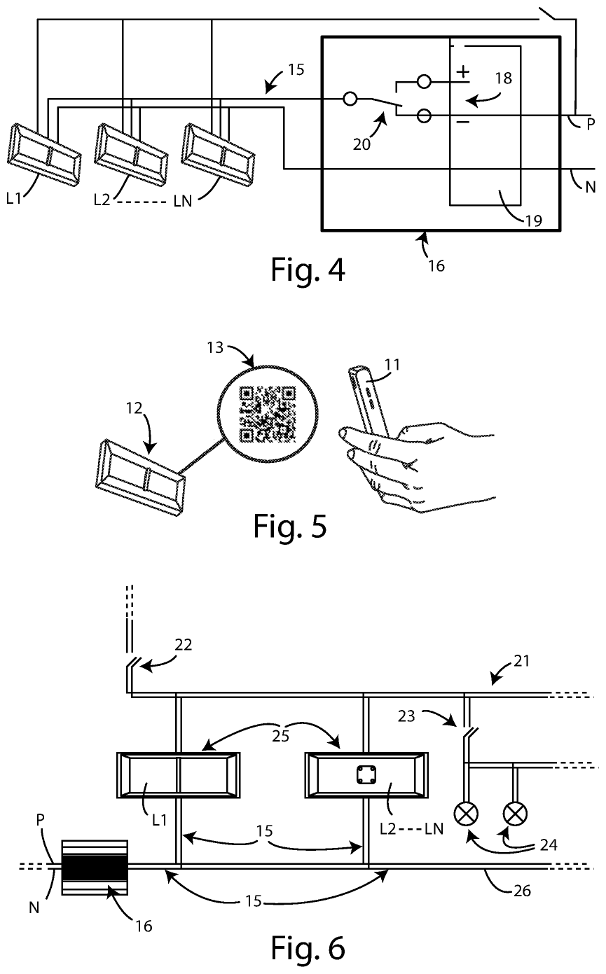

FIG. 4 shows an enlarged block diagram of one of the components of FIG. 3;

FIG. 5 shows a schematic view of an operating mode of the control apparatus according to the invention, integrating that shown in FIGS. 2 and 3;

FIG. 6 shows a schematic circuit diagram of another operating mode of the control apparatus according to the invention.

With reference to the accompanying drawings, the apparatus for remote control of emergency lighting equipment, according to the invention, is based on the use of the flash 10 of a smartphone or tablet 11 as data transmission source and of one or more lighting appliances or emergency lamps 12. The flash 10 of the smartphone or tablet 11 has minimum characteristics and, controlled by a specific software application (APP), allows the sending of coded signals according to the proprietary protocol of the emergency lamp 12, in such a way that the communication from the smartphone or tablet 11 to the lamp 12 occurs with ON/OFF cycles of the flash 10 of the smartphone or tablet 11, with an ON/OFF frequency of a few tens of Hz. The choice of this type of transmitter is dictated by the widespread use of smartphones and tablets, as well as the wish to simplify the work of the personnel responsible for installation and maintenance of the emergency lamps 12, avoiding the use of further devices such as centralised control units and/or remote control devices.

For the transmission phase use is made of a software application (APP) operating inside the smartphone or tablet 11 which is able to send optical commands by modulating the switching ON and OFF of the flash 10 of the smartphone or tablet 11; the APP is designed to send coded luminous messages by means of the flash 10.

Basically, by using the dedicated APP, it is possible to interact directly with a single emergency lamp through a one-way optical communication; it is therefore possible to modify the configuration parameters of each single lamp, start the diagnostic tests and carry out other advanced functions.

Each lighting appliance or emergency lamp 12 can be used in the following configurations or operating mode:
“autotest”, according to which the emergency lamp 12 can operate in “stand alone” mode, carrying out the functions typical of an “autotest” emergency lamp (minimum configuration of use of the emergency lamp 12); by cutting a bridge it is possible to configure the autonomy of the emergency lamp;
“Cablecom® optical mode” operation, according to which the lamp 12 is able to receive luminous commands of the actuation type or simply configuration commands, using the smartphone or tablet 11, during installation, that is, a predefined time window from the time in which the power supply is provided;
operation with “basic control unit”, according to which a series of emergency lamps 12, all mounted on a dedicated line, communicate on the power supply bus controlled directly upstream by a special local control unit controlled with just a few buttons, a multi-turn rotary switch, some selection LEDs and a LED for the result of the tests (system status);
operation with “advanced control unit”, according to which a series of emergency lamps 12, all mounted on a dedicated line, communicate on the power supply bus controlled directly upstream by a special WI-FI control unit; a dedicated APP allows the WI-FI connection to the control unit allowing the installer to control the system from a smartphone by means of an advanced interface.

According to the “Cablecom® optical mode”, the emergency lamp 12 can be controlled and configured using the luminous commands of the flash of the smartphone or tablet 11 by means of a special APP installed on the smartphone or tablet 11 (FIG. 1).

The optical communication, of the one-way type, is characterised by actuation type commands or simple configuration commands. The commands which can always be actuated on the lamp 12 are “operational test start”, “stop test” and “rest mode”; this basically a remote control of the test button of the lamp 12.

The other commands provided can, on the other hand, only be actuated following a synchronisation procedure of the mains AC power supply; more in detail, once the mains power supply is provided, it must be removed and restored in less than 3 seconds (that is, a mains power supply of less than 3 seconds must be generated) and from the time in which the synchronisation procedure is completed a time window of 2 hours is opened, within which the lamp 12 can receive all the actuation and/or configuration commands provided by the APP.

This enables maximum safety of the system of emergency lamps to be achieved, since only the installer who has access to the control panel can remove or provide the power supply to the lamps and consequently enable the use of the optical commands.

The emergency lamp 12 will respond to the commands received by actuating the command (and, in this case, the user will have a visual check on the operation, since the lamp will switch ON or OFF) or generate an “acknowledge” flashing light (command received correctly) for the configuration commands received.

The optical commands relative to the “Cablecom® optical mode” implemented in the APP are as follows:
operational test start and operational test stop (basic functions, which can always be actuated);
hours of autonomy in emergency mode as a function of the luminous flow emitted (configuration command which can be actuated in the time window of 2 hours);
setting SE, SA, PS functions, odd and even (configuration commands which can be actuated in the time window of 2 hours);
start autonomy test, stop autonomy test, sync lamps and rest mode off with lamp in emergency mode (actuation commands which can be actuated in the time window of 2 hours);
set test duration, set test duration equal to autonomy, factory reset (advanced functions which can be actuated in the time window of 2 hours).

Each emergency lamp 12 is identified by a unique number present inside the firmware of the apparatus and inside a QR-Code 13 shown on the lamp 12; this identification code is fundamental if the emergency lamp 12 is used in the operating mode with “basic control unit” or with “advanced control unit”, as described below.

According to the operating mode with “basic control unit”, the emergency lamps 12 (indicated with L1, L2, . . . , LN in FIGS. 2 and 3) are mounted on a dedicated emergency line 18, upstream of which is installed a control unit 16; the requirement to wire the lamps on the dedicated emergency line 18 is good and normal practice.

The emergency lamps L1, L2, . . . , LN continue to operate completely autonomously, according to the autotest mode described above, until the control unit 16 is inserted upstream of the dedicated power supply line 18; in this configuration the lamps L1, L2, . . . , LN acquire the capacity to receive and send data (FIG. 2).

The dedicated power supply line 18 can be fitted with a maximum of 32 lamps L1, L2, . . . , LN, but preferably the systems have approximately ten lamps.

The control unit 16 is able to switch the power supply line 18 onto a communication bus 15 by simulating the lack of mains power supply 14 and operating the lamps by battery; in this condition it is possible to set up a two-way and immediate communication between the individual lamps and the control unit 16 and, in short, the power supply bus 18 switched by the control unit 16 becomes a low voltage communication bus 15 (FIGS. 3 and 4).

For this reason it is fundamental that the power supply bus 18 is polarised; consequently, during wiring and/or installation it is necessary to comply with the correct polarity P, N.

Basically, the power supply line P, N enters into the control unit 16 with the neutral N through and the phase P, alternatively, either through or switched on the low voltage bus 18, in order to manage a power of approximately 3 kW for powering the lamps in ordinary operation and providing 250 mA at 12V during data transmission.

In this way, the system is able to communicate with the lamps by means of the bus 15 which uses the emergency electrical system for data transmission (basically, a “Power over Bus” (PoB) system is adopted applied to the emergency lighting sector, with high energy available on the bus and limited costs); in particular, the control unit 16 is able to connect with the lamps switching the two power supply cables in the communication bus 15, so as to avoid any possibility of interference between the data transmission and the passage of current.

Once the lamps L1, L2, . . . , LN and the control unit 16 are wired it is necessary to activate the system by means of a configuration phase during which the control unit 16 searches for all the lamps present in the system.

The control unit 16 can consist of two embodiments: “basic control unit” and “advanced control unit”.

The control unit 16, in the “basic control unit” version, is a module consisting of a 12 Volt power supply unit 19, a relay 20 which is able to switch the mains power supply bus (230 Vac) on the communication bus (12V) and the communication and interfacing electronics consisting of buttons for actuating the various functions, configuration rotary switch and signalling LEDs (FIG. 4).

In the operating mode with “advanced control unit”, the control unit 16 expands the functionalities of the “basic control unit” described above with a WI-FI communication module; in that case, by using a smartphone or tablet and using a dedicated APP, it is possible to connect to the local WI-FI network generated by the control unit 16 and thereby the control unit 16 is able to show status information for the system with details of each individual lamp, as well as receive actuation and configuration commands both broadcast and oriented to the individual lamp.

All the lamps are fitted with a micro-switch which is able to carry out an operational diagnosis either autonomously or by receiving commands from the communication bus 15 and to communicate the test results in local mode through a code of flashes and/or colours of special status LEDs; when the control unit 16 switches the line P on the bus 15 it is able to communicate with the lamps, requesting the results of the tests or communicating set-up instructions, whilst when the lamps are connected to the communication bus 15 they can communicate to the control unit 16 the result of the tests or the status of the parameters of each lamp.

In particular, as well as the configuration procedure, which will be described below, the “basic control unit” 16 allows operational tests to be performed (tests for switching ON the emergency lamp for 30 seconds), autonomy test (tests for switching ON the emergency lamp for a predetermined duration in autonomous mode), a stop of the tests being performed and a function for inhibition of the emergency in the case of switching OFF of the system (rest mode).

The function selected (with relative green LED switched ON) is executed by pressing “OK” on the control unit 16, whilst the outcome of the function started is shown on the status LED which switches ON red (with flashes of various durations) in the case of errors and green if there is no error.

The commands sent and the information collected by the control unit 16 are oriented to the entire system; consequently, a red status LED will indicate that at least one of the lamps of the system has an error or fault and it will be the responsibility of the user to inspect the signalling LEDs of the individual lamps to identify the lamp with the fault.

In order to carry out the configuration procedure of the system, the control unit 16 must know the number of lamps L1, L2, . . . , LN connected on the dedicated line before actuating any command; a preliminary configuration phase is therefore necessary in which to actuate the recognition of all the lamps.

In the case of a system with a “basic” control unit 16 the installer, after wiring all the emergency lamps L1, L2, . . . , LN, selects the configuration function and, by means of the multi-turn rotary switch of the control unit 16, defines the number of lamps present in the system, then selects the desired autonomy and selects the configuration phase by pressing “OK”.

The LED of the control unit 16 switches ON with the colour green if the number of lamps configured with the rotary selector coincides with the number of lamps which the control unit 16 has detected. If this number does not coincide, the control unit 16 sends an orange switching ON command of the signalling LED to all the lamps detected, in such a way that the lamps which remain with the steady green LED (or, possibly, steady red) can be considered as those not detected by the control unit 16 and the installer can therefore resolve any fault. In practice, the signalling LED can be used as a guide for searching the number of lamps connected to the control unit 16.

As in the case of use of the control unit 16 of the “basic” type, also in the case of use of the control unit 16 of the “advanced” type, the control unit must know the number of lamps L1, L2, . . . , LN connected on the dedicated line 18 before actuating any command.

In this case, the installer, once the dedicated APP has been downloaded and installed, will find two buttons: “remote control” and “Cablecom® connect control unit management”.

In the “remote control” mode, the installer can, anonymously (without registering), access the optical commands and can send the commands directly, in a one-way direction, as described above with regard to the “Cablecom® optical mode”.

In the “Cablecom® connect control unit management” mode, the advanced control unit 16 automatically generates a WI-FI network (in Access Point mode), to which it is possible to connect by smartphone and specific APP. Once the connection has been executed, the user will have complete control of the control unit 16 and will be able to send/receive commands and collect system data. The configurations and the commands can be performed both in broadcast mode and in individual mode (oriented to the individual lamp). The dedicated APP includes all the basic functions present on the user interface of the “basic” control unit, as well as the advanced functions for data collection and configuration of system and/or lamps.

The basic commands which are available and which can be actuated by the APP are those for configuration of the system, operational test start, autonomy test start, stop test, rest mode.

Further commands/advanced configurations available by means of the dedicated APP regard the programming of automatic tests (with definition of the periodicity and the start date of the first test and with programming which can be actuated both for the operational tests and for the autonomy tests), status of the system (summary of the data of the emergency lamps configured in the control unit, association of a test to each lamp present in the list to have a position reference of the lamp or a description which can be easily interpreted, configuration for each individual lamp present with specific parameters oriented to the individual lamp), a regular logbook of the results of the automatic tests (the user is able to download a pdf document generated following a certain periodic autonomy test or periodic operational test; the report can be saved and if necessary shared or sent via mail and contains the date and time of the data of the automatic test, type of automatic test performed, identification number and/or descriptive text of the individual lamp, fault found and/or test result).

Basically, by using the Wi-Fi technology of the control unit 16, it is possible to configure the entire system, start operational tests and autonomy tests, modify the parameters of each lamp and enable advanced functionalities. The above-mentioned advanced functionalities include the one illustrated in detail in the appended FIG. 6; the system layout shown highlights the simplicity of the function. Basically, considering that the power supply cable 21 of the ordinary lighting, the system of which comprises a protection device 22 and a control device 23 of lamps 24 for the ordinary lighting, is the same on which the control unit 16 transmits the data for the control of the emergency lamps L1, L2, . . . LN, it is possible, by using respective input connectors 25 wired between the cable 21 and the lamps L1, L2 . . . LN, to activate the normal emergency operation of the lamps L1, L2 . . . LN even in the case of a local power failure of a section of the ordinary lighting system. Upon completion of the nominal autonomy of each lamp L1, L2 . . . LN, the bus 15 supplies the energy necessary to keep the lamp L1, L2 . . . LN switched ON with practically infinite autonomy (possibly with a reduced luminous flow) providing there is power supply on the emergency supply line 26.

Therefore, by enabling this function, the PoB (“Power over Bus”) technology allows, in the case of a local emergency, the emergency lamps L1, L2 . . . LN (recovery function) to continue to be powered even if the local lighting line is interrupted; in this way possible to obtain an extension of autonomy with nominal luminous flow and a standby reduced luminous flow, which activated automatically when the battery of the lamp L1, L2 . . . LN is flat (or broken), in order to anyway guarantee a useful service (for example, in the case of exits from premises due to night-time faults and/or on construction sites, etc.).

The technical features of the apparatus and the relative method for the remote control of emergency lighting equipment, according to the invention, clearly emerge from the description, as do the advantages thereof.

In particular, as well as the advantages mentioned above, the following should be noted:
simplified two-wire wiring;
possibility of use of the system on standard emergency lamps, without having to intervene on the electrical system;
communication reliability without interference problems even with communication distances greater than 250 metres and also indoors;
possibility of continuing to power the emergency lamp even in the case of a power failure of the local lighting line, with extension of the autonomy of the lamp with a nominal luminous flow and continuous activation of a reduced luminous flow (with flat of broken battery);
possibility of transforming the SE lamps into SA, if necessary with a reduced flow, in order to archive a night-time lighting;
no generation of electrosmog.

Lastly, it is clear that numerous other variants might be made to the apparatus and to the method in question, without forsaking the principles of novelty of the inventive idea expressed in the appended claims, whilst it is clear that, in the practical actuation of the invention, the materials, the shapes and the dimensions of the details illustrated can be of any type, according to requirements, and can be replaced by other equivalent elements.

1. An apparatus for a remote control of emergency lighting equipment comprising:
a smartphone or tablet provided with at least one flash configured to send optical commands in the form of coded luminous messages and a control system managed by a software application or APP running in the smartphone or tablet and able to modulate the switching on and off of said flash of the smartphone or tablet, and
a series of emergency lamps and a central unit, wherein emergency lamp of said series of emergency lamps is configured to receive said optical commands from said smartphone or tablet for performing functional tests or remote configurations, both during the installation of each emergency lamp and for a fixed period of time starting from the mains power supply is restored to each emergency lamp after being removed for a prefixed period of time,
wherein a polarized supply line is provided for supplying said series of emergency lamps and said central unit, placed upstream of said polarized supply line, is configured to manage said polarized supply line and data received from said series of emergency lamps, said central unit being configured to switch said polarized supply line into a communication bus, said communication bus being configured to supply said series of emergency lamps and to transmit data to said series of emergency lamps, said central unit comprising a low voltage power supply and an electronic communication circuit which includes a series of light emitting diodes (LEDs) which are provided for signaling a correct operation and/or errors and each emergency lamp having a micro-switch configured to receive commands from said communication bus and to transmit signals of a correct operation and/or errors through said signaling LEDs.

2. (canceled)

3. The apparatus as claimed in claim 1, wherein a relay of said central unit is configured to switch said polarized supply line into a low voltage bus.

4. The apparatus as claimed in claim 1, wherein said optical commands are sent to said series of emergency lamps, through said central unit, so as to perform functional tests, autonomy tests, synchronization tests, tests related to the hours of emergency autonomy of said series of emergency lamps.

5. The apparatus as claimed in claim 1, wherein at least one of each emergency lamp or said central unit is identified by a unique number of a QR-Code.

6. The apparatus as claimed in claim 1, wherein each emergency lamp is configured to receive said optical commands via said APP running in said smartphone or tablet.

7. The apparatus as claimed in claim 1, wherein said central unit comprises a WI-FI communication module and a software application or APP running in said central unit is configured to show a status information of said emergency lighting equipment and of each emergency lamp, as well as to receive actuation and configuration commands addressed to said emergency lighting equipment and/or to each emergency lamp.

8. The apparatus as claimed in claim 7, wherein said central unit is configured to send and receive at least one of actuation or configuration commands and collect at least one of the data relating to each emergency lamp or data relating to said emergency lighting equipment, said commands including periodic automatic test programs, plant status checks and periodic collections of test results.

9. The apparatus as claimed in claim 1, wherein said apparatus comprises input connectors and a cable for supplying ordinary lighting, said input connectors being provided between said cable for supplying ordinary lighting and each emergency lamp in order to activate an emergency function of said series of emergency lamps in case of blackout of a section of an ordinary lighting system, said communication bus being able to supply energy for supplying at least one of said series of emergency lamps with a nominal luminous flux for a first period of time and with a reduced luminous flux at the end of said first period of time.

10. (canceled)
